(19) United States
(12) Patent Application Publication
(10) Pub. No.: US 2019/0008309 A1
(43) Pub. Date: Jan. 10, 2019

(54) SPLIT ELECTRIC RICE COOKER

(71) Applicant: FOSHAN SHUNDE MIDEA ELECTRICAL HEATING APPLIANCES MANUFACTURING CO., LIMITED, Foshan (CN)

(72) Inventors: Linbo ZHU, Foshan (CN); Chuanbin ZHU, Foshan (CN); Xianhuai CHEN, Foshan (CN); Wei YUAN, Foshan (CN); Zhixiao LUO, Foshan (CN); Zhengting FU, Foshan (CN); Yuquan WU, Foshan (CN); Wei CHEN, Foshan (CN)

(21) Appl. No.: 16/131,036

(22) Filed: Sep. 14, 2018

Related U.S. Application Data
(63) Continuation of application No. PCT/CN2017/117262, filed on Dec. 19, 2017.

(30) Foreign Application Priority Data
Mar. 31, 2017 (CN) 201720340884.4

(51) Int. Cl. A47J 27/00

(52) U.S. Cl. CPC A47J 27/004

(57) ABSTRACT

The present disclosure provides a split electric rice cooker. The split electric rice cooker includes: a base; and a cooker configured to rest on the base and separable with respect to the base, the cooker being provided with an inner pot therein and having a cooker bottom wall, the cooker bottom wall being located below the inner pot, and the cooker bottom wall being constructed as a single-layer wall structure.

### CROSS-REFERENCE TO RELATED APPLICATIONS

This application is a continuation of International Application PCT/CN2017/117262, filed on Dec. 19, 2017, which claims priority to and the benefit of Chinese Patent Application No. 201720340884.4 filed with the Chinese Patent Office on Mar. 31, 2017, the entire contents of which are incorporated herein by reference.

### FIELD

The present disclosure relates to a technical field of household appliances, and specifically to a split electric rice cooker.

### BACKGROUND

For a split electric rice cooker in the related art, a distance between a heating element and an inner pot must be kept relatively small so that the inner pot can be well heated by a sensing element. In addition, a plastic piece (a cooker body) is disposed between the inner pot and a base (including the heating element) so that the inner pot and the base are spaced apart, and a distance between the inner pot and the plastic piece should be kept relatively large so that the plastic piece doesn't deform due to the influence of the heat of the inner pot. For this reason, the inner pot is generally arranged relatively far away from the heating element, that is, the inner pot is raised to avoid the above situation. However, this approach not only enlarges a volume of the electric rice cooker, increases the cost, but also leads to a poor heating effect.

### SUMMARY

The present disclosure seeks to solve one of the technical problems existing in the related art to at least some extent.

Thus, an embodiment of the present disclosure is to propose a split electric rice cooker having better safety performance.

The split electric rice cooker according to embodiments of the present disclosure includes: a base; and a cooker configured to rest on the base and separable with respect to the base, the cooker being provided with an inner pot therein and having a cooker bottom wall, the cooker bottom wall being located below the inner pot, and the cooker bottom wall being constructed as a single-layer wall structure.

With the split electric rice cooker according to embodiments of the present disclosure, not only a volume of the cooker is reduced, the cost is saved, but also the heating efficiency is higher and the safety performance is better.

In addition, the split electric rice cooker according to embodiments of the present disclosure can further have the additional technical features as follows.

In the split electric rice cooker according to an embodiment of the present disclosure, the cooker includes: a base plate provided with a base-plate through hole; a cooker body fixed to the base plate; an inner-pot heat insulation piece provided in the cooker body, the inner-pot heat insulation piece including a circumferential wall surrounding the inner pot and the bottom wall located below the inner pot, a bottom-wall protrusion protruding downwards being formed in the bottom wall of the inner-pot heat insulation piece, the bottom-wall protrusion being fitted in the base-plate through hole, so that the bottom-wall protrusion constitutes the single-layer wall structure.

According to some embodiments of the present disclosure, a lower surface of the bottom-wall protrusion is flush with a lower surface of the base plate.

According to some embodiments of the present disclosure, an inner diameter of the base-plate through hole is equal to an outer diameter of the bottom-wall protrusion.

According to some embodiments of the present disclosure, an inner diameter of the base-plate through hole is not smaller than an outer diameter of an outer bottom surface of the inner pot.

According to some embodiments of the present disclosure, the inner pot and the base-plate through hole are arranged coaxially.

According to some embodiments of the present disclosure, the base-plate through hole is circular.

According to some embodiments of the present disclosure, the inner-pot heat insulation piece is a plastic piece.

According to some embodiments of the present disclosure, the circumferential wall of the inner-pot heat insulation piece is spaced apart from the inner pot.

According to some embodiments of the present disclosure, an upper circumferential edge of the inner-pot heat insulation piece extends upwards up to an upper flange of the inner pot.

According to some embodiments of the present disclosure, a thickness of the inner-pot heat insulation piece is 1.5-2.8 mm.

In the split electric rice cooker according to another embodiment of the present disclosure, the cooker includes: a base plate provided with a base-plate protrusion protruding upwards; the cooker body fixed to the base plate; an inner-pot heat insulation piece provided in the cooker body, the inner-pot heat insulation piece including a circumferential wall surrounding the inner pot and the bottom wall located below the inner pot, a bottom-wall through hole being formed in the bottom wall of the inner-pot heat insulation piece, the base-plate protrusion being fitted in the bottom-wall through hole, so that the base-plate protrusion constitutes the single-layer wall structure.

Embodiments of present disclosure will be given in part in the following description, become apparent in part from the following description, or be learned from the practice of the embodiments of the present disclosure.

### BRIEF DESCRIPTION OF THE DRAWINGS

FIG. 1 is a schematic view of a split electric rice cooker according to embodiments of the present disclosure.

FIG. 2 is a partially enlarged view illustrating an area A in FIG. 1.

### REFERENCE NUMERALS:

split electric rice cooker 1000, base 100,

cooker 200, base plate 210, base-plate through hole 214, cooker body 220, inner-pot heat insulation piece 230, bottom-wall protrusion 234.

### DETAILED DESCRIPTION

The embodiments of the present disclosure are described in detail below, and examples of the embodiments are shown in the accompanying drawings, in which the same or similar reference numerals denote the same or similar elements or elements having the same or similar functions throughout. The embodiments described herein with reference to drawings are explanatory, illustrative, and used to generally understand the present disclosure, and cannot be construed to limit the present disclosure.

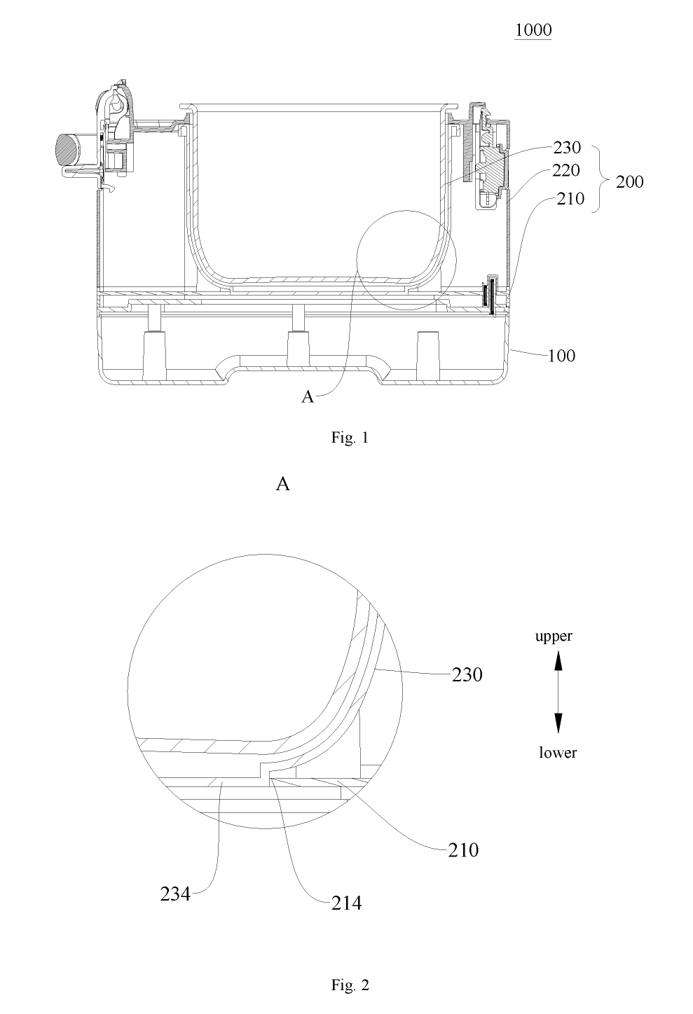

A split electric rice cooker 1000 according to embodiments of the present disclosure will be described in detail with reference to FIG. 1 to FIG. 2.

The split electric rice cooker 1000 according to embodiments of the present disclosure includes: a base 100; and a cooker 200 configured to rest on the base 100 and separable with respect to the base 100. The base 100 is a base for heating i.e. for heating an inner pot in the cooker 200.

The cooker 200 is provided with the inner pot therein and has a cooker bottom wall. The cooker bottom wall is located below the inner pot and is constructed as a single-layer wall structure.

In the split electric rice cooker according to embodiments of the present disclosure, with the bottom wall of the cooker 200 being constructed as the single-layer wall structure to reduce a distance between the inner pot and the plastic piece, not only a volume of the cooker 200 is reduced, the cost is saved, but also the heating efficiency is higher and the safety performance is better.

As illustrated in FIG. 1, the split electric rice cooker 1000 according to embodiments of the present disclosure includes the cooker 200. The cooker 200 includes a base plate 210, a cooker body 220 and an inner-pot heat insulation piece 230. As illustrated in FIG. 2, the base plate 210 is provided with a base-plate through hole 214, the cooker body 220 is fixed to the base plate 210. The inner-pot heat insulation piece 230 is provided in the cooker body 220 and includes a circumferential wall surrounding the inner pot and the bottom wall located below the inner pot. A bottom-wall protrusion 234 protruding downwards is formed in the bottom wall of the inner-pot heat insulation piece 230, the bottom-wall protrusion 234 is fitted in the base-plate through hole 214, so that the bottom-wall protrusion 234 constitutes the single-layer wall structure.

In the split electric rice cooker 1000 according to embodiments of the present disclosure, by providing the inner-pot heat insulation piece 230 with the bottom-wall protrusion 234 and providing the base plate 210 with the base-plate through hole 214 for the bottom-wall protrusion 234 to extend into, a distance between a heating element and the inner pot is reduced and the heat transfer efficiency is increased, and moreover, the inner-pot heat insulation piece 230 is prevented from interfering with the base plate 210 by arranging the bottom-wall through hole, a volume of the cooker 200 is reduced and the cost is saved. Meanwhile, the bottom-wall protrusion 234 is increased in distance from the inner pot, so that an amount of heat radiated from the inner pot to the bottom-wall protrusion 234 is greatly reduced, such that the bottom-wall protrusion 234 is not easy to age or catch fire and has longer service life, thus improving the safety performance of the use of the electric rice cooker.

It should be noted that the base 100 is provided with the heating element for heating an inner container of the cooker 200. The heating element includes, but is not limited to, an electromagnetic heating element. The base 100 is provided with a plug for adapting to an external power supply. The heating element can be powered after the plug is plugged in, and hence the heating element is enabled to emit heat to transfer heat to the inner container of the cooker 200.

As illustrated in FIG. 2, a lower surface of the bottom-wall protrusion 234 is flush with a lower surface of the base plate 210. Thus, the cooker 200 has a flush bottom and exhibits a more artistic appearance.

In order to improve the seal property of the cooker 200, an inner diameter of the base-plate through hole 214 can be equal to an outer diameter of the bottom-wall protrusion 234.

In some embodiments of the present disclosure, an inner diameter of the base-plate through hole 214 is not smaller than an outer diameter of an outer bottom surface of the inner pot.

As illustrated in FIG. 1, the inner pot and the base-plate through hole 214 are arranged coaxially. Thus, the heat transfer from the heating element to the inner pot is more even.

In one embodiment, the base-plate through hole 214 can be circular. Certainly, the present disclosure is not limited to this, the base-plate through hole 214 can also be a square hole, an elliptical hole or the like.

The inner-pot heat insulation piece 230 is a plastic piece. Thus, a weight of the cooker 200 can be further reduced.

In some embodiments of the present disclosure, the circumferential wall of the inner-pot heat insulation piece 230 is spaced apart from the inner pot. Thus, the heat insulation effect is better, the aging of the inner-pot heat insulation piece 230 caused by being used for too long is avoided, and the service life of the inner-pot heat insulation piece 230 is prolonged.

In some embodiments of the present disclosure, an upper circumferential edge of the inner-pot heat insulation piece 230 extends upwards up to an upper flange of the inner pot. In this way, the inner-pot heat insulation piece 230 also insulates heat of the flange of the inner pot, and the cooker 200 is protected more comprehensively.

As illustrated in FIG. 2, the inner-pot heat insulation piece 230 has a thickness of 1.5-2.8 mm.

Certainly, the single-layer wall structure of the bottom wall of the cooker 200 is not limited to the specific embodiment illustrated in FIG. 1. In some other embodiments, the cooker includes: the base plate 210, the cooker body 220 and the inner-pot heat insulation piece 230. The base plate 210 is provided with a base-plate protrusion protruding upwards, the cooker body 220 is fixed to the base plate 210, and the inner-pot heat insulation piece 230 is provided in the cooker body 220. The inner-pot heat insulation piece 230 includes the circumferential wall surrounding the inner pot and the bottom wall located below the inner pot. A bottom-wall through hole is formed in the bottom wall of the inner-pot heat insulation piece, the base-plate protrusion is fitted in the bottom-wall through hole, so that the base-plate protrusion constitutes the single-layer wall structure.

In this way, the distance between the inner pot and the plastic piece can also be reduced, hence the volume of the cooker 200 is reduced, the cost is saved, and the heating efficiency is higher and the safety performance is better.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise” “axially,” “radially,” and “circumferentially” should be construed to refer to the orientation as then described or as shown in the drawings under discussion. These relative terms are for convenience of description and do not require that the present disclosure be constructed or operated in a particular orientation, thus cannot be construed to limit the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or more than two, unless specified otherwise.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures;

may also be inner communications of two elements

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

What is claimed is:

1. A split electric rice cooker, comprising:
a base;
a cooker configured to rest on the base and separable with respect to the base, the cooker being provided with an inner pot therein and having a cooker bottom wall, the cooker bottom wall being located below the inner pot, and the cooker bottom wall being constructed as a single-layer wall structure.

2. The split electric rice cooker according to claim 1, wherein the cooker further comprises:
a base plate provided with a base-plate through hole;
a cooker body fixed to the base plate;
an inner-pot heat insulation piece provided in the cooker body, the inner-pot heat insulation piece comprising a circumferential wall surrounding the inner pot and the bottom wall located below the inner pot, a bottom-wall protrusion protruding downwards being formed in the bottom wall of the inner-pot heat insulation piece, the bottom-wall protrusion being fitted in the base-plate through hole, so that the bottom-wall protrusion constitutes the single-layer wall structure.

3. The split electric rice cooker according to claim 2, wherein a lower surface of the bottom-wall protrusion is flush with a lower surface of the base plate.

4. The split electric rice cooker according to claim 2, wherein an inner diameter of the base-plate through hole is not smaller than an outer diameter of an outer bottom surface of the inner pot.

5. The split electric rice cooker according to claim 2, wherein the inner pot and the base-plate through hole are arranged coaxially.

6. The split electric rice cooker according to claim 2, wherein the inner-pot heat insulation piece is a plastic piece.

7. The split electric rice cooker according to claim 2, wherein the circumferential wall of the inner-pot heat insulation piece is spaced apart from the inner pot.

8. The split electric rice cooker according to claim 2, wherein an upper circumferential edge of the inner-pot heat insulation piece extends upwards up to an upper flange of the inner pot.

9. The split electric rice cooker according to claim 2, wherein a thickness of the inner-pot heat insulation piece is 1.5-2.8 mm.

10. The split electric rice cooker according to claim 1, wherein the cooker further comprises:
a base plate provided with a base-plate protrusion protruding upwards;
a cooker body fixed to the base plate;
an inner-pot heat insulation piece provided in the cooker body, the inner-pot heat insulation piece comprising a circumferential wall surrounding the inner pot and the bottom wall located below the inner pot, a bottom-wall through hole being formed in the bottom wall of the inner-pot heat insulation piece, the base-plate protrusion being fitted in the bottom-wall through hole, so that the base-plate protrusion constitutes the single-layer wall structure.
